(19) United States
(12) Patent Application Publication
(10) Pub. No.: US 2020/0028127 A1
(43) Pub. Date: Jan. 23, 2020

(54) SECONDARY BATTERY

(71) Applicant: Samsung SDI Co., Ltd., Yongin-si (KR)

(72) Inventors: Hiroshi Seino, Yongin-si (KR); Jeong Chull Ahn, Yongin-si (KR); Sang Hyun Kim, Yongin-si (KR)

(21) Appl. No.: 16/507,876

(22) Filed: Jul. 10, 2019

(30) Foreign Application Priority Data
Jul. 17, 2018 (KR) 10-2018-0083083

(51) Int. Cl. H01M 2/02

(52) U.S. Cl. CPC H01M 2/024; H01M 2/0217

(57) ABSTRACT

A secondary battery includes: an electrode assembly; a pouch case accommodating the electrode assembly; and a finishing tape attached to an outer surface of the electrode assembly and contacting an inner surface of the pouch case.

### CROSS-REFERENCE TO RELATED APPLICATION

This application claims priority to and the benefit of Korean Patent Application No. 10-2018-0083083, filed on Jul. 17, 2018 in the Korean Intellectual Property Office (KIPO), the entire content of which is herein incorporated by reference.

### BACKGROUND

### 1. Field

Aspects of embodiments of the present invention relate to a secondary battery.

### 2. Description of the Related Art

Different from a primary battery that is not designed to be charged (e.g., recharged), a secondary battery is designed to be charged (e.g., recharged) and discharged. A low-capacity secondary battery may be used as a power source for various portable small-sized electronic devices, such as smart phones, feature phones, notebook computers, digital cameras, camcorders, and so on. A high-capacity secondary battery may be used as a power source for electric motors, such as those in hybrid vehicles and electric vehicles, or as a power storage cell.

A secondary battery generally includes an electrode assembly including a positive electrode and a negative electrode, a case accommodating the electrode assembly, and electrode terminals connected to the electrode assembly. The case may be classified as a circular type, a prismatic type, or a pouch type according to its external shape. The pouch type secondary battery can be easily formed in various shapes and may use a light-weight laminate case.

The above information disclosed in this Background section is for enhancement of understanding of the background of the described technology, and therefore, it may contain information that does not form prior art that is already known to a person of ordinary skill in the art.

### SUMMARY

Embodiments of the present invention provide a secondary battery with improved safety against falls (or drops) by preventing an electrode assembly from moving inside a pouch case or by reducing movement of the electrode assembly inside the pouch case.

According to an embodiment of the present invention, a secondary battery including: an electrode assembly; a pouch case accommodating the electrode assembly; and a finishing tape attached to an outer surface of the electrode assembly and contacting an inner surface of the pouch case.

The finishing tape may include the same material as that of the inner surface of the pouch case.

The finishing tape may include a cast polypropylene (CPP) film.

The finishing tape may have a melting point higher than 140° C.

The finishing tape may cover 20% to 50% of the electrode assembly.

When the finishing tape is immersed in an electrolytic solution, a static coefficient of friction between the finishing tape and the inner surface of the pouch case may be greater than 5.

When the finishing tape is immersed in an electrolytic solution, a dynamic coefficient of friction between the finishing tape and the inner surface of the pouch case may be greater than 3.5.

The finishing tape may include a pattern layer on a surface of the finishing tape, and the pattern layer may be formed by plasma treatment.

A frictional force between the finishing tape and the inner surface of the pouch case may be configured to prevent the electrode assembly from moving inside the pouch case.

As described above, in the secondary battery according to an embodiment of the present invention, the electrode assembly may not move (or may not substantially move) inside a pouch case by attaching a finishing tape having a large frictional force with an inner surface of the pouch case to an outer surface of the electrode assembly, thereby improving safety against falls, drops, or impacts.

In addition, in the secondary battery according to an embodiment of the present invention, when a force exceeding a static frictional force between the finishing tape and the inner surface of the pouch case is applied to the secondary battery, the electrode assembly may move inside the pouch case, thereby preventing the electrode assembly from being damaged or reducing damage to the electrode assembly.

### BRIEF DESCRIPTION OF THE DRAWINGS

FIG. 1 is a perspective view of a secondary battery according to an embodiment of the present invention.

FIG. 2 is a cross-sectional view of the secondary battery shown in FIG. 1.

FIG. 3 is an enlarged cross-sectional view of the portion A of FIG. 2.

FIG. 4 is a cross-sectional view of a finishing tape according to another embodiment of the present invention.

FIG. 5 is a cross-sectional view of a finishing tape according to another embodiment of the present invention.

### DETAILED DESCRIPTION

Hereinafter, embodiments of the present invention will be described in detail. The present invention, however, may be embodied in many different forms and should not be construed as being limited to the example embodiments set forth herein. Rather, these example embodiments are provided so that this disclosure will be thorough and complete and will convey the present disclosure to those skilled in the art.

In addition, in the accompanying drawings, sizes or thicknesses of various components or layers may be exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A may be directly connected to the element B or an intervening element C may be present and the element A and the element B may be indirectly connected to each other.

Further, the use of “may” when describing embodiments of the present invention relates to “one or more embodiments of the present invention.” Also, the term “exemplary” is intended to refer to an example or illustration. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

The terminology used herein is for the purpose of describing particular embodiments and is not intended to be limiting of the disclosure. As used herein, the singular forms are intended to include the plural forms as well, unless the context clearly indicates otherwise. It will be further understood that the terms “comprise” or include” and/or “comprising” or “including,” when used in this specification, specify the presence of stated features, numbers, steps, operations, elements, and/or components but do not preclude the presence or addition of one or more other features, numbers, steps, operations, elements, components, and/or groups thereof.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “over” or “above” the other elements or features. Thus, the exemplary term “below” can encompass both an orientation of above and below.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

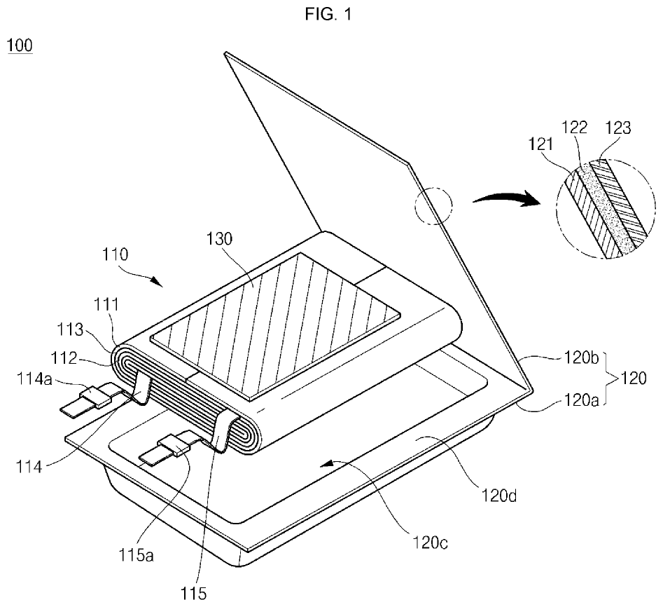

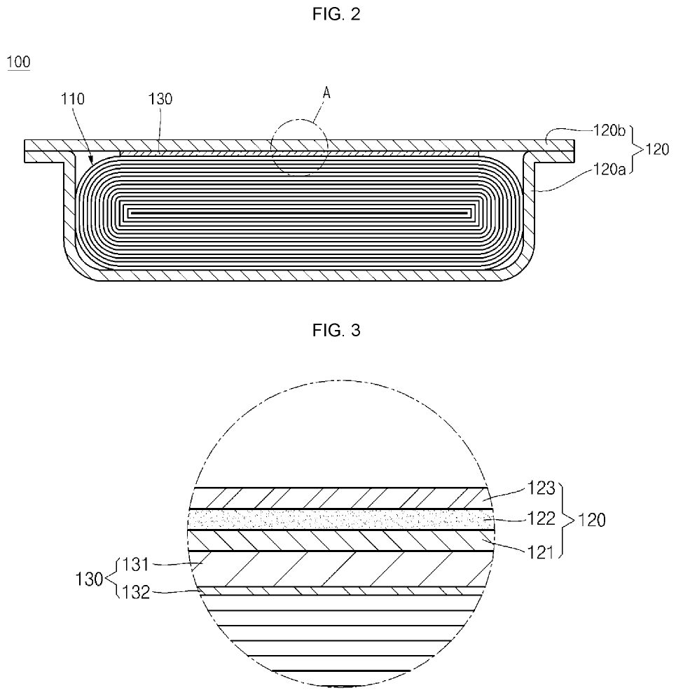

FIG. 1 is a perspective view of a secondary battery according to an embodiment of the present invention, and FIG. 2 is a cross-sectional view of the secondary battery shown in FIG. 1.

Referring to FIGS. 1 and 2, the secondary battery 100 according to an embodiment of the present invention includes an electrode assembly 110, a pouch case (e.g., a pouch type case) 120, and a finishing tape 130.

The electrode assembly 110 includes a first electrode 111, a second electrode 112, and a separator 113 positioned between the first electrode 111 and the second electrode 112. The electrode assembly 110 may be formed by winding a stacked structure of the first electrode 111, the separator 113, and the second electrode 112 in a jelly-roll configuration. In one embodiment, the first electrode 111 may be a positive electrode, and the second electrode 112 may be a negative electrode, but the present invention is not limited thereto.

The first electrode 111 is formed by coating a first electrode active material, such as a transition metal oxide, on a first electrode current collector made of (or including) a metal foil including, for example, aluminum. A first electrode non-coating portion, on which first electrode active material is not coated, is located on the first electrode 111, and a first electrode tab 114 is attached to the first electrode non-coating portion. One end of the first electrode tab 114 is electrically connected to the first electrode 111, and the other end thereof is exposed from the pouch case 120. An insulation member 114a is attached to the first electrode tab 114 to prevent a short-circuit from occurring between the pouch case 120 and the first electrode tab 114.

The second electrode 112 is formed by coating a second electrode active material, such as graphite or carbon, on a second electrode current collector made of (or including) a metal foil including, for example, copper or nickel. A second electrode non-coating portion, on which the second electrode active material is not coated, is located on the second electrode 112, and a second electrode tab 115 is attached to the second electrode non-coating portion. One end of the second electrode tab 115 is electrically connected to the second electrode 112, and the other end thereof is exposed from the pouch case 120. An insulation member 115a is attached to the second electrode tab 115 to prevent a short-circuit from occurring between the pouch case 120 and the second electrode tab 115.

The separator 113 may be positioned between the first electrode (e.g., the first electrode plate) 111 and the second electrode (e.g., the second electrode plate) 112 to prevent short-circuiting therebetween and to allow movement of lithium ions. The separator 113 may be made of (or may include) polyethylene, polypropylene, or a composite film including polyethylene and polypropylene. The electrode assembly 110 is accommodated in the pouch case 120 together with an electrolyte. The electrolyte may include an organic solvent, such as EC, PC, DEC, EMC, or DMC, and a lithium salt, such as LiPF₆ or LiBF₄. In addition, the electrolyte may be in a liquid, solid or gel phase.

The pouch case 120 includes a lower case 120a in which the electrode assembly 110 is accommodated and an upper case 120b coupled to the lower case 120a. The pouch case 120 may be divided into (e.g., may be formed of) the upper case 120b and the lower case 120a by folding a mid-portion of a rectangular pouch layer (e.g., by folding a continuous rectangular layer or sheet at its midpoint). In addition, an accommodation groove (or accommodation recess) 120c, in which the electrode assembly 110 is to be accommodated, is provided in the lower case 120a through pressing, and a sealing part 120d is provided to seal the lower case 120a and the upper case 120b to each other.

The sealing part 120d may be located along one side where the upper case 120b and the lower case 120a integrally contact each other (by, for example, folding) and along three other sides (e.g., three other sides where the upper case 120b and the lower case 120a are folded to contact each other). The pouch case 120 includes two long sides where the upper case 120b and the lower case 120a face each other and two short sides perpendicular to the two long sides and facing each other. In the illustrated embodiment, the first electrode tab 114 and the second electrode tab 115 of the electrode assembly 110 are drawn out through one of the two short sides, which faces the other short side at where the upper case 120b and the lower case 120a are integrally connected to each other. The insulation members 114a and 115a, which are respectively attached to the first electrode tab 114 and the second electrode tab 115, are sealed with the sealing part 120d. For example, the insulation members 114a and 115a are respectively located at portions where the first electrode tab 114 and the second electrode tab 115 contact the sealing part 120d, thereby preventing the first electrode tab 114 and the second electrode tab 115 from short-circuiting with the pouch case 120.

In addition, the pouch case 120 has a multi-layer structure including a first insulation layer 121, a metal layer 122, and a second insulation layer 123.

The first insulation layer 121 defines an inner surface of the pouch case 120 (e.g., the first insulation layer 121 is an innermost surface of the pouch case 120) and is made of (or includes) a material having an insulating property and a thermally adhesive property. For example, the first insulation layer 121 is located on a first surface of the metal layer 122 facing the electrode assembly 110 to define the inner surface of the pouch case 120. The first insulation layer 121 may be made of (or may include) cast polypropylene (CPP), which is not reactive with an electrolyte, or equivalents thereof, but the present invention is not limited thereto. When the electrode assembly 110 is accommodated in the accommodation groove 120c of the lower case 120a and is covered by the upper case 120b, the first insulation layers 121 of the lower case 120a and the upper case 120b contact each other. When the sealing part 120d of the pouch case 120 is thermally fused (e.g., when the sealing part 120d is formed by thermal fusion), the first insulation layers 121 of the lower case 120a and the upper case 120b are adhered to each other, thereby sealing the pouch case 120.

The metal layer 122 is positioned between the first insulation layer 121 and the second insulation layer 123 to prevent or reduce external moisture and oxygen from penetrating into the pouch case 120 and to prevent or reduce the risk of an electrolyte filled in the pouch case 120 from leaking out. In addition, the metal layer 122 maintains the mechanical strength of the pouch case 120. The metal layer 122 may be made of (or may include), for example, aluminum, stainless steel, copper, or equivalents thereof. However, in view of formability and lightness in weight, the metal layer 122 may be made of (or may include) aluminum.

The second insulation layer 123 defines an outer surface (e.g., an outermost surface) of the pouch case 120 and reduces (or mitigates) mechanical impacts to an external electronic device to which the secondary battery 100 is connected. In addition, the second insulation layer 123 is formed on a second surface of the metal layer 122, thereby forming the exterior surface of the pouch case 120. The second insulation layer 123 may be made of (or may include) nylon, polyethylene terephthalate (PET), polybutylene terephthalate (PBT), polybutylene naphthalate (PBN), or equivalents thereof.

Because extra space (e.g., a void or gap) generally exists between a pouch case and an electrode assembly accommodated therein, movement of the electrode assembly with respect to the pouch case may occur during a drop test for testing the performance of a secondary battery. Due to this movement, edge portions of the electrode assembly may be shorted or an electrode tab may be short-circuited during a drop test. Therefore, according to embodiments of the present invention, a finishing tape 130 having a relatively high frictional force with the pouch case 120 is attached to the outer surface of the electrode assembly 110 to prevent (or reduce) movement of the electrode assembly 110 inside the pouch case 120, thereby improving safety of the secondary battery 100.

The finishing tape 130 is attached to cover (e.g., to partially cover) the outer surface of the electrode assembly 110. The finishing tape 130 is made of (or includes) a material having a relatively high frictional force with the inner surface of the pouch case 120, that is, with the first insulation layer 121, to prevent or substantially reduce movement of the electrode assembly 110 inside the pouch case 120. For example, a fixing force between the electrode assembly 110 and the pouch case 120 may be secured due to the frictional force between the finishing tape 130 and the first insulation layer 121 of the pouch case 120. In addition, because the finishing tape 130 is not adhered to (e.g., is not fixed to) the pouch case 120, the electrode assembly 110 may move inside the pouch case 120 when a force exceeding the static frictional force between the finishing tape 130 and the first insulation layer 121 is applied thereto, thereby preventing or reducing damage to an electrode current collector of the electrode assembly 110. As an example, when an electrode assembly is completely attached to (e.g., is fixed to) a pouch case, quite a strong fixing force may be present between the electrode assembly and the pouch case such that the electrode current collector of the electrode assembly, for example, an aluminum (Al) first electrode current collector, may be cracked due to impacts applied during a drop test. As a result, the secondary battery may short-circuit or the capacity of the secondary battery may be reduced.

According to embodiments of the present invention, however, the electrode assembly 110 has a fixing force inside the pouch case 120 due to the frictional force between the finishing tape 130 and the first insulation layer 121 of the pouch case 120. Therefore, when a force exceeding the static frictional force between the finishing tape 130 and the first insulation layer 121 of the pouch case 120 is applied, the electrode assembly 110 may move inside the pouch case 120, thereby preventing or reducing damage to the electrode current collector of the electrode assembly 110.

FIG. 3 is an enlarged cross-sectional view of the portion A of FIG. 2, illustrating an area where the finishing tape 130 is adhered to the electrode assembly 110 of the secondary battery 100.

In an example embodiment, the finishing tape 130 may be made of (or may include) the same material as that of the inner surface of the pouch case 120, that is, the first insulation layer 121. For example, a cast polypropylene (CPP) film may be used as the finishing tape 130. As shown in FIG. 3, the finishing tape 130 may include a CPP film 131 and an adhesive layer 132 prepared by coating an adhesive on the CPP film 131. In the illustrated embodiment, the adhesive layer 132 is a surface attached to (e.g., directly contacts) the electrode assembly 110, and the CPP film 131 is a surface contacting (e.g., directly contacts) the inner surface of the pouch case 120, that is, the first insulation layer 121. Examples of the adhesive layer 132 include a rubber-based adhesive, an acryl-based adhesive, a silicon-based adhesive, a hot melt adhesive, etc. In addition, the finishing tape 130 may include a polymer having a melting point of about 140° C. or higher. Examples of the polymer having a melting point of about 140° C. or higher include cast polypropylene (CPP), a combination of CPP and polyethylene (PE), a combination of CPP and a copolymer, etc. Some examples of the copolymer include maleic anhydride, vinyl acetate, n-butyl acrylate, 1,4-Hexadiene, etc., and a proportion of the copolymer to the CPP may be about 10 mol % or less.

The finishing tape 130 may have a tensile strength in a range from about 5.5 N/4 mm to about 7.0 N/4 mm. When the finishing tape 130 has a tensile strength in the range stated above, movement of the electrode assembly 110 within the pouch case 120 may be effectively suppressed.

The finishing tape 130 may have a shear modulus in a range from about 0.1 GPa to about 0.2 GPa. When the finishing tape 130 has a shear modulus in the range stated above, movement of the electrode assembly 110 within the pouch case 120 may be effectively suppressed.

The finishing tape 130 may have a Young's modulus in a range from about 0.4 GPa to about 0.6 GPa. When the finishing tape 130 has a Young's modulus in the range stated above, movement of the electrode assembly 110 within the pouch case 120 may be effectively suppressed.

A static coefficient of friction between the finishing tape 130 and the first insulation layer 121 of the pouch case 120 may be in a range from about 5 to about 7, and a dynamic coefficient of friction between the finishing tape 130 and the first insulation layer 121 of the pouch case 120 may be in a range from about 3.5 to about 4.6. Here, the static coefficient of friction and the dynamic coefficient of friction between the finishing tape 130 and the first insulation layer 121 may be measured when the finishing tape 130 is immersed in an electrolytic solution, that is, in a wet condition. When the static coefficient of friction and the dynamic coefficient of friction are in the ranges stated above, movement of the electrode assembly 110 within the pouch case 120 may be effectively suppressed.

The finishing tape 130 may have an elongation in a range from about 650% to about 850%. When the finishing tape 130 has an elongation in the range stated above, movement of the electrode assembly 110 within the pouch case 120 may be effectively suppressed.

In addition, while the finishing tape 130 is attached to only one surface of the electrode assembly 110 in the illustrated embodiment, the finishing tape 130 may be attached to both (e.g., two) surfaces of the electrode assembly 110 (e.g., a second finishing tape 130 may be provided on the other side of the electrode assembly 110, or the one finishing tape 130 may extend onto the other side of the electrode assembly 110). The finishing tape 130 may cover about 20% to about 50% of the electrode assembly 110. When the finishing tape 130 covers less than about 20% of the electrode assembly 110, an adequate fixing force between the electrode assembly 110 and the pouch case 120 may not be secured. In addition, when the finishing tape 130 covers greater than about 50% of the electrode assembly 110, the finishing tape 130 may cover more of the electrode assembly 110 than is necessary for the desired fixing force, making the secondary battery 100 unnecessarily bulky.

The finishing tape 130 may have a thickness in a range from about 10 μm to about 40 μm. When the finishing tape 130 has a thickness in the range stated above, the secondary battery 100 may be less affected in view of capacity and may have high strength and excellent manufacturability. For example, when the thickness of the finishing tape 130 is smaller than about 10 μm, the finishing tape 130 may be difficult to manufacture, and when the thickness of the finishing tape 130 is greater than about 40 μm, the finishing tape 130 may become thicker than is necessary, making the secondary battery 100 unnecessarily bulky.

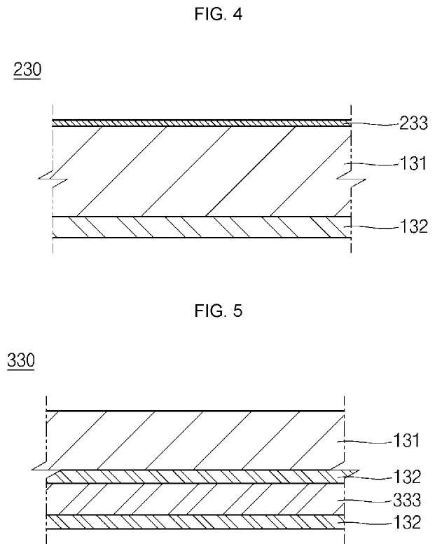

FIG. 4 is a cross-sectional view of a finishing tape according to another embodiment of the present invention.

Referring to FIG. 4, the finishing tape 230 may be subjected to plasma treatment on its surface, further increasing a frictional force between the finishing tape 230 and the inner surface of the pouch case 120. For example, the finishing tape 230 may include a CPP film 131, an adhesive layer 132 positioned on one surface of the CPP film 131, and a pattern layer 233 on the other surface (e.g., on the surface opposite the adhesive layer 132) of the CPP film 131. In the illustrated embodiment, the adhesive layer 132 is surface attached to the electrode assembly 110, and the pattern layer 233 is in surface contact with the inner surface of the pouch case 120, that is, the first insulation layer 121. The pattern layer 233 has flextures or patterns produced by performing vacuum plasma treatment or atmospheric plasma treatment on the CPP film 131. Therefore, the pattern layer 233 improves frictional force between the finishing tape 230 and the pouch case 120.

FIG. 5 is a cross-sectional view of a finishing tape according to another embodiment of the present invention.

Referring to FIG. 5, the finishing tape 330 may further include a separate polymer layer 333 located within a CPP film 131. For example, the finishing tape 330 may include the CPP film 131, a first adhesive layer 132, the polymer layer 333, and a second adhesive layer 132 stacked in that order. The polymer layer 333 may be made of (or may include) polyethylene terephthalate (PET), orientated polystyrene (OPS), thermoplastic polyurethane (TPU), polyvinylidene difluoride (PVDF), and/or oriented polypropylene (OPP). In addition, because the polymer layer 333 is positioned inside the CPP film 131, it does not contact the pouch case 120, and therefore, a frictional force between the finishing tape 330 and the pouch case 120 is not affected by the polymer layer 333.

To investigate safety performance of the secondary battery according to embodiments of the present invention, a drop test was performed in the following manner.

A secondary battery having a finishing tape attached to one surface of an electrode assembly was prepared with the finishing tape covering 20% of the electrode assembly and having a thickness of 35 μm. An adhesive was coated on the finishing tape to a thickness of 5 μm. Thirty secondary batteries were prepared for each of the following examples. In the respective examples, static coefficients of friction and dynamic coefficients of friction were measured when the finishing tapes were in wet conditions (e.g., when the finishing tapes were submerged in an electrolytic solution) and averages of the measured coefficients were obtained. After a total of four cycles of drop tests were performed, with 18 drop tests per cycle for a total of 72 drop tests, heat generation, open-circuit voltage (OCV) drop, and cracking of an aluminum (Al) base material of each electrode assembly were checked. The results are summarized below in Table 1.

In Table 1, 30 secondary batteries of each of Examples 1-4 and Comparative Examples 1-5 were each subjected to 72 drops tests, and the number of secondary batteries that did not generate heat after being subjected to 72 drop tests is indicated by A. In addition, from among the secondary batteries that did not generate heat, OCV drops were determined. A standard for determining OCV drops is a voltage difference of 50 mV or less before and after drop testing. In addition, in Table 1, a number of OKs in OCV drops, abbreviated as B, indicates a number of secondary batteries having a voltage difference of 50 mV or less before and after drop testing so as to be judged as OK, which corresponds to a number of secondary batteries without OCV drops. In addition, a number of secondary batteries without cracks in an Al base material of each electrode assembly from among the secondary batteries without OCV drops, abbreviated as C, was checked.

### Example 1

A CPP film was used as a finishing tape.

### Example 2

A CPP-PE film was used as a finishing tape and a propylene:ethylene ratio of the CPP-PE was 95:5 by mol %.

### Example 3

A CPP-PE film was used as a finishing tape and a propylene:ethylene ratio of the CPP-PE was 70:30 by mol %.

### Example 4

A CPP-copolymer film was used as a finishing tape. In this example, a propylene:copolymer ratio was 95:5 by mol %, and maleic anhydride was used as the copolymer

### Comparative Example 1

An OPS film was used as a finishing tape, which was thermally adhered to a pouch case.

### Comparative Example 2

A TPU film was used as a finishing film.

### Comparative Example 3

A PVDF film was used as a finishing film.

### Comparative Example 4

A PET film was used as a finishing film.

### Comparative Example 5

An OPP film was used as a finishing film.

TABLE 1

| | Wet static | Wet dynamic | | | |
|---|---|---|---|---|---|
| | friction | friction | | | |
| | coefficient | coefficient | A | B | C |
| Example 1 (CPP) | 6.91 | 3.56 | 30/30 | 30/30 | 30/30 |
| Example 2 | 6.73 | 3.87 | 30/30 | 30/30 | 30/30 |
| (CPP-PE) | | | | | |
| Example 3 | 6.45 | 4.35 | 30/30 | 30/30 | 30/30 |
| (CPP-PE) | | | | | |
| Example 4 | 6.82 | 3.58 | 30/30 | 30/30 | 30/30 |
| (CPP-copolymer) | | | | | |
| Comparative | 7.02 | 6.05 | 30/30 | 29/30 | 4/29 |
| Example 1 (OPS) | | | | | |
| Comparative | 4.39 | 3.33 | 19/30 | 14/19 | 14/14 |
| Example 2 (TPU) | | | | | |
| Comparative | 0.78 | 0.55 | 15/30 | 8/15 | 8/8 |
| Example 3 | | | | | |
| (PVDF) | | | | | |
| Comparative | 4.19 | 2.20 | 22/30 | 19/22 | 19/19 |
| Example 4 (PET) | | | | | |
| Comparative | 4.76 | 2.63 | 24/30 | 21/24 | 21/21 |
| Example 5 (OPP) | | | | | |

As evident from Table 1, secondary batteries manufactured according to Examples 1-4, which used a CPP film, CPP-PE films, and a CPP-copolymer film as finishing tapes, did not demonstrate heat generation, OCV drops, and Al base material cracking even after being subjected to 72 drop tests. For example, the secondary batteries manufactured according to Examples 1-4 were all evaluated as being good after being subjected to the drop tests due to friction between each of the CPP-based films used as the finishing tapes and the internal surface of pouch cases.

Because a secondary battery manufactured according to Comparative Example 1, in which an OPS film is thermally attached to the pouch case, an electrode assembly of this secondary battery exhibited a relatively high fixing force such that heat generation did not occur. However, in Comparative Example 1, an Al base material of the electrode assembly was liable to crack during the drop tests. In a secondary battery manufactured according to Comparative Example 2, because a TPU film was swollen and wrinkled due to absorbing the electrolytic solution, a contact area between the TPU film and the inner surface of the pouch case was reduced and any improvement due to friction between the TPU film and the pouch case was not demonstrated in the drop tests. In a secondary battery manufactured according to Comparative Example 3, because a PVDF film was swollen and wrinkled due to absorbing the electrolytic solution, a contact area between the PVDF film and the inner surface of the pouch case was reduced and any improvement due to friction between the PVDF film and the pouch case was not demonstrated in the drop tests. In addition, because the PVDF film was made of a material having a relatively small frictional force and a small intermolecular force, low friction and little resistance against drop testing were demonstrated in the secondary battery manufactured according to Comparative Example 3. In a secondary battery manufactured according to Comparative Example 4, a PET film absorbed a small amount of the electrolytic solution and was not wrinkled. However, because a frictional force between the PET film and the inner surface of the pouch case was not high, the frictional force between the electrode assembly and the pouch case was low, suggesting that the secondary battery manufactured according to Comparative Example 4 was not highly resistant to drop testing. In a secondary battery manufactured according to Comparative Example 5, because an OPP film is a biaxially-stretched product and demonstrates poor rubber elasticity and insufficient friction compared to the CPP film, the resistance to drop testing was insufficient. In addition, whereas the respective finishing tapes of Comparative Examples 2-5 had wet static friction coefficients of lower than 5, the respective finishing tapes of Examples 1-4 had wet static friction coefficients of greater than 5. In addition, whereas the respective finishing tapes of Comparative Examples 2-5 had wet dynamic friction coefficients of lower than 3.5, the respective finishing tapes of Examples 1-4 had wet dynamic friction coefficients of greater than 3.5. Accordingly, it is understood that the finishing tapes according to Examples 1-4 may provide a secondary battery having improved safety by suppressing movement of the electrode assembly during drop testing. Although the finishing tape of Comparative Example 1 had a wet static friction coefficient of greater than 5 and a wet dynamic friction coefficient of greater than 3.5, it is thermally adhered to the pouch case, thereby rendering the Al base material of the electrode assembly vulnerable to cracking.

While the present invention has been shown and described with reference to example embodiments thereof, it will be understood by those of ordinary skill in the art that various changes in form and details may be made to the described embodiments without departing from the spirit and scope of the present invention as defined by the following claims and their equivalents.

Explanation of Some Reference Numerals

| | |
|---|---|
| 100: Secondary battery | 110: Electrode assembly |
| 120: Pouch case | 121: First insulation layer |
| 122: Metal layer | 123: Second insulation layer |
| 130, 230, 330: Finishing tape | |

What is claimed is:

1. A secondary battery comprising:
an electrode assembly;
a pouch case accommodating the electrode assembly; and
a finishing tape attached to an outer surface of the electrode assembly and contacting an inner surface of the pouch case.

2. The secondary battery of claim 1, wherein the finishing tape comprises the same material as that of the inner surface of the pouch case.

3. The secondary battery of claim 1, wherein the finishing tape comprises a cast polypropylene (CPP) film.

4. The secondary battery of claim 1, wherein the finishing tape has a melting point higher than 140° C.

5. The secondary battery of claim 1, wherein the finishing tape covers 20% to 50% of the electrode assembly.

6. The secondary battery of claim 1, wherein, when the finishing tape is immersed in an electrolytic solution, a static coefficient of friction between the finishing tape and the inner surface of the pouch case is greater than 5.

7. The secondary battery of claim 1, wherein, when the finishing tape is immersed in an electrolytic solution, a dynamic coefficient of friction between the finishing tape and the inner surface of the pouch case is greater than 3.5.

8. The secondary battery of claim 1, wherein the finishing tape comprises a pattern layer on a surface of the finishing tape, and
wherein the pattern layer is formed by plasma treatment.

9. The secondary battery of claim 1, wherein a frictional force between the finishing tape and the inner surface of the pouch case is configured to prevent the electrode assembly from moving inside the pouch case.
